(19) United States
(12) Patent Application Publication
(10) Pub. No.: US 2010/0318722 A1
(43) Pub. Date: Dec. 16, 2010

(54) DATA INTERLEAVING METHOD FOR STORAGE DEVICE AND RELATED STORAGE DEVICE

(76) Inventors: Chao-Yin Liu, Hsinchu City (TW); Ming-Cheng Chen, Changhua County (TW)

Correspondence Address: NORTH AMERICA INTELLECTUAL PROPERTY CORPORATION, P.O. BOX 506, MERRIFIELD, VA, 22116, US

(21) Appl. No.: 12/508,541

(22) Filed: Jul. 23, 2009

(30) Foreign Application Priority Data
Jun. 15, 2009 (TW) 098119914

(51) Int. Cl. G06F 12/02; G06F 12/00

(52) U.S. Cl. 711/103; 711/157; 711/E12.001; 711/E12.008

(57) ABSTRACT

The present invention provides a data interleaving method for a storage device and a related storage device. The storage device comprises a plurality of non-volatile memory units, a buffer, and a processing unit. The method comprises: transmitting a plurality of first data required to be written to the plurality of non-volatile memory units to the buffer one by one; and respectively performing a plurality of interleaving operations to transmit the plurality of first data received by the buffer in sequence to the plurality of non-volatile memory units, respectively. The data interleaving method and the related storage device of the present invention only has to use one buffer, and thus the data interleaving method and the related storage device of the present invention can reduce requirement of buffer memory.

### BACKGROUND OF THE INVENTION

1. Field of the Invention

The present invention relates to a data interleaving method and a related storage device, and more particularly, to a data interleaving method that only needs to use one buffer for a storage device and a related storage device.

2. Description of the Prior Art

Please refer to FIG. 1. FIG. 1 shows a simplified block diagram of a conventional storage device 100. As shown in FIG. 1, the storage device 100 comprises: two non-volatile memory units 110, 120, two buffers 130, 140, and a processing unit 150, wherein the non-volatile memory units 110, 120 can be NAND type flash memories, and the storage device 100 can be a solid state drive (SSD). The buffer 130 is coupled to the non-volatile memory units 110, 120. The processing unit 150 is coupled to the non-volatile memory units 110, 120 and the buffers 130, 140, and utilized for transmitting data required to be written to the non-volatile memory unit 110 to the buffer 130 and transmitting data required to be written to the non-volatile memory unit 120 to the buffer 140 simultaneously, and performing an interleaving operation to transmit the data received by the buffer 130 to the non-volatile memory unit 110 and transmit the data received by the buffer 140 to the non-volatile memory unit 120. However, when one more non-volatile memory unit is added, one more corresponding buffer is required to be added, and thus this conventional data interleaving method and the related storage device require more buffers.

### SUMMARY OF THE INVENTION

It is therefore one of the objectives of the present invention to provide a data interleaving method that only needs to use one buffer for a storage device and a related storage device, and thus the method and the related storage device of the present invention can reduce a required number of the buffer.

In accordance with an embodiment of the present invention, a data interleaving method for a storage device is disclosed, wherein the storage device comprises a plurality of non-volatile memory units and a buffer. The method comprises: transmitting a plurality of first data required to be written to the plurality of non-volatile memory units to the buffer one by one; and respectively performing a plurality of interleaving operations to transmit the plurality of first data received by the buffer in sequence to the plurality of non-volatile memory units, respectively.

In accordance with another embodiment of the present invention, a storage device is disclosed. The storage device comprises: a plurality of non-volatile memory units, a buffer, and a processing unit. The buffer is coupled to the plurality of non-volatile memory units. The processing unit is coupled to the plurality of non-volatile memory units and the buffer, and utilized for transmitting a plurality of first data required to be written to the plurality of non-volatile memory units to the buffer one by one, and respectively performing a plurality of interleaving operations to transmit the plurality of first data received by the buffer in sequence to the plurality of non-volatile memory units, respectively.

Briefly summarized, the data interleaving method for a storage device and the related storage device disclosed by the present invention only needs to use one buffer, and thus the method and the related storage device of the present invention can reduce the required number of the buffer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of a conventional storage device.

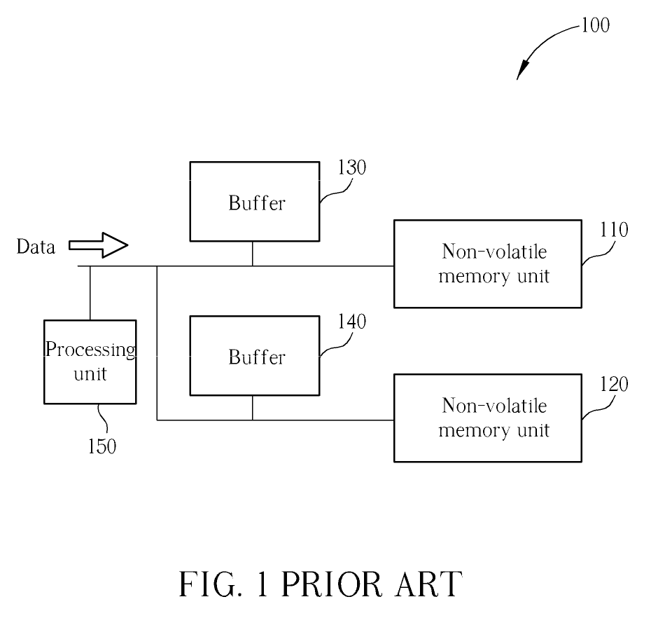

FIG. 2 shows a simplified block diagram of a storage device in accordance with an embodiment of the present invention.

FIG. 3 shows a timing diagram of a method in accordance with a first embodiment of the present invention.

FIG. 4 is a first flowchart showing a data interleaving method that only needs to use one buffer for a storage device in accordance with the operation schemes of the storage device in the above embodiment of the present invention.

FIG. 5 shows a timing diagram of a method in accordance with a second embodiment of the present invention.

FIG. 6 is a second flowchart showing a data interleaving method that only needs to use one buffer for a storage device in accordance with the operation schemes of the storage device in the above embodiment of the present invention.

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

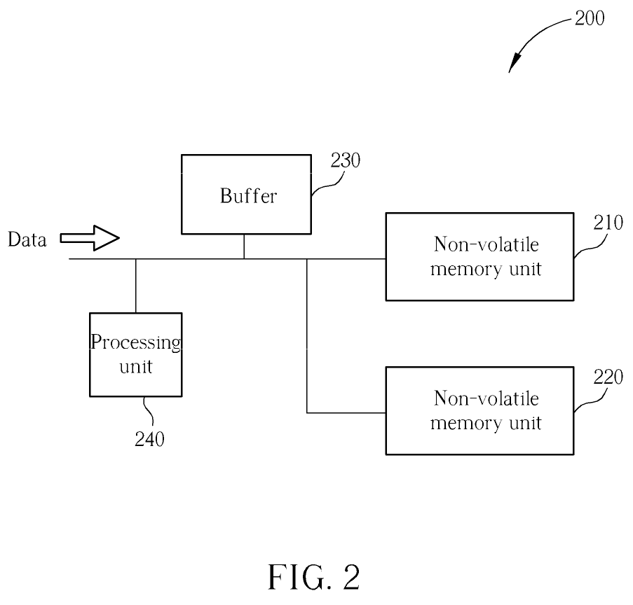

The present invention relates to a data interleaving method that only needs to use one buffer for a storage device and a related storage device. Please refer to FIG. 2. FIG. 2 shows a simplified block diagram of a storage device 200 in accordance with an embodiment of the present invention. As shown in FIG. 2, the storage device 200 comprises: two non-volatile memory units 210, 220, a buffer 230, and a processing unit 240, wherein the non-volatile memory units 210, 220 can be NAND type flash memories, and the storage device 200 can be a solid state drive (SSD). The buffer 230 is coupled to the non-volatile memory units 210, 220. The processing unit 240 is coupled to the non-volatile memory units 210, 220 and the buffer 230, and utilized for transmitting a plurality of first data required to be written to the non-volatile memory units 210, 220 to the buffer 230 one by one, and respectively performing a plurality of interleaving operations to transmit the plurality of first data received by the buffer 230 in sequence to the non-volatile memory units 210, 220, respectively.

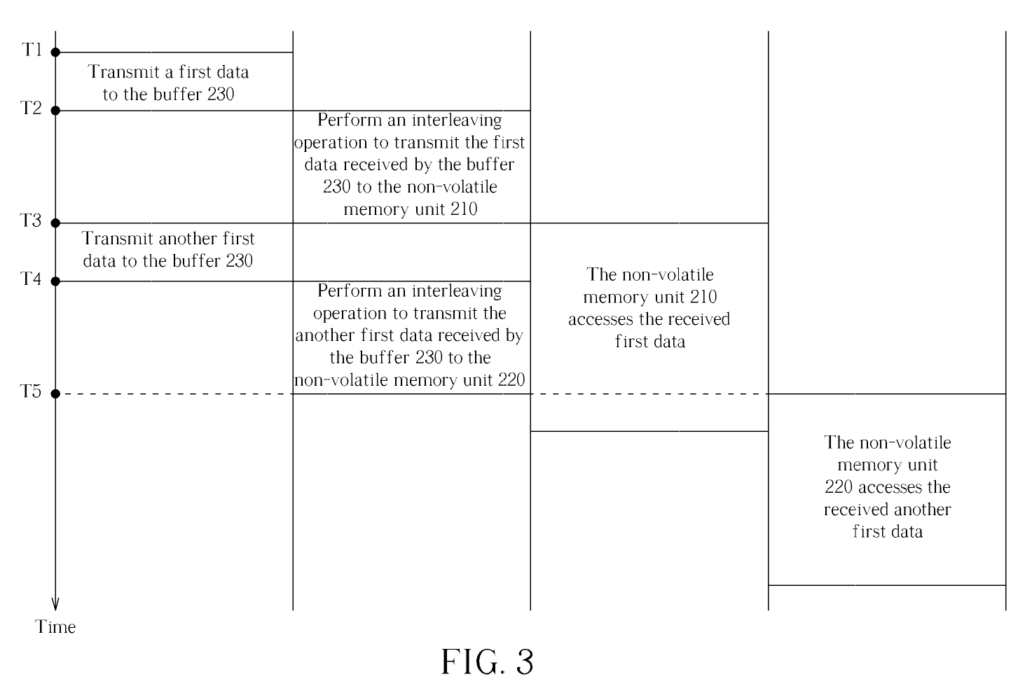

Please refer to FIG. 3. FIG. 3 shows a timing diagram of a method in accordance with a first embodiment of the present invention. As shown in FIG. 3, the method comprises: starting to transmit a first data to the buffer 230 at time point T1; next, starting to perform an interleaving operation to transmit the first data received by the buffer 230 to the non-volatile memory unit 210 at time point T2; next, starting to transmit another first data to the buffer 230 at time point T3, and the non-volatile memory unit 210 accesses the received first data simultaneously; next, starting to perform an interleaving operation to transmit the another first data received by the buffer 230 to the non-volatile memory unit 220 at time point T4; next, the non-volatile memory unit 220 accesses the received another first data simultaneously at time point T5; next, waiting for the non-volatile memory unit 220 to finish accessing the another first data, and after the non-volatile memory unit 220 finishes accessing the another first data, starting to transmit a plurality of second data required to be written to the non-volatile memory units 210, 220 to the buffer 230 one by one; that is, repeating the above steps. In addition, please note that the above embodiment is only for an illustrative purpose and is not meant to be a limitation of the present invention. For example, the number of the non-volatile memory units in the storage device 200 can be more than two.

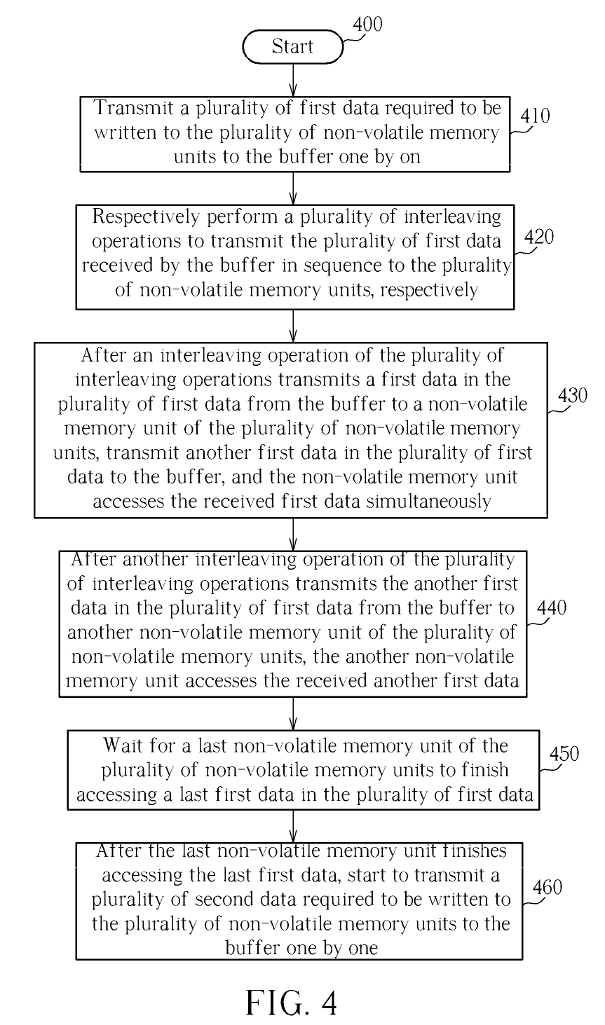

Please refer to FIG. 4. FIG. 4 is a first flowchart showing a data interleaving method that only needs to use one buffer for a storage device in accordance with the operation schemes of the storage device 200 in the above embodiment of the present invention. Provided that substantially the same result is achieved, the steps of the process flowchart need not be in the exact order shown in FIG. 4 and need not be contiguous, that is, other steps can be intermediate. The method in accordance with the first embodiment of the present invention comprises the following steps:

Step 400: Start.

Step 410: Transmit a plurality of first data required to be written to the plurality of non-volatile memory units to the buffer one by on.

Step 420: Respectively perform a plurality of interleaving operations to transmit the plurality of first data received by the buffer in sequence to the plurality of non-volatile memory units, respectively.

Step 430: After an interleaving operation of the plurality of interleaving operations transmits a first data in the plurality of first data from the buffer to a non-volatile memory unit of the plurality of non-volatile memory units, transmit another first data in the plurality of first data to the buffer, and the non-volatile memory unit accesses the received first data simultaneously.

Step 440: After another interleaving operation of the plurality of interleaving operations transmits the another first data in the plurality of first data from the buffer to another non-volatile memory unit of the plurality of non-volatile memory units, the another non-volatile memory unit accesses the received another first data.

Step 450: Wait for a last non-volatile memory unit of the plurality of non-volatile memory units to finish accessing a last first data in the plurality of first data.

Step 460: After the last non-volatile memory unit finishes accessing the last first data, start to transmit a plurality of second data required to be written to the plurality of non-volatile memory units to the buffer one by one.

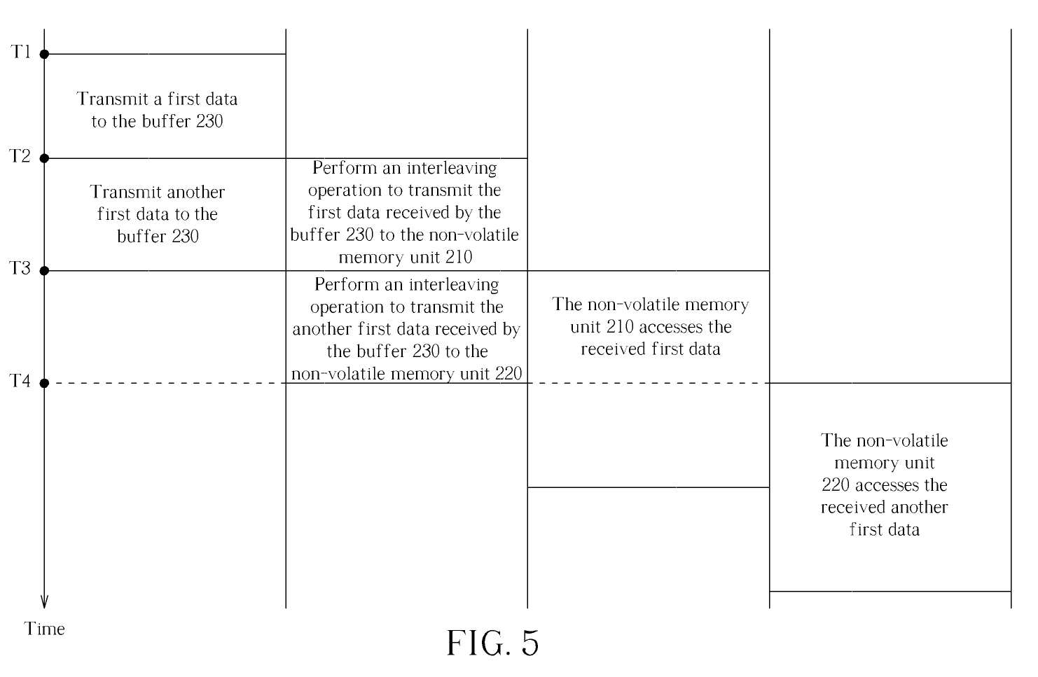

Please refer to FIG. 5. FIG. 5 shows a timing diagram of a method in accordance with a second embodiment of the present invention. As shown in FIG. 5, the method comprises: starting to transmit a first data to the buffer 230 at time point T1; next, starting to perform an interleaving operation to transmit the first data received by the buffer 230 to the non-volatile memory unit 210 at time point T2, and starting to transmit another first data to the buffer 230 simultaneously; next, the non-volatile memory unit 210 accesses the received first data at time point T3, and starting to perform an interleaving operation to transmit the another first data received by the buffer 230 to the non-volatile memory unit 220 simultaneously; next, the non-volatile memory unit 220 accesses the received another first data simultaneously at time point T4; next, waiting for the non-volatile memory unit 220 to finish accessing the another first data, and after the non-volatile memory unit 220 finishes accessing the another first data, starting to transmit a plurality of second data required to be written to the non-volatile memory units 210, 220 to the buffer 230 one by one; that is, repeating the above steps. In addition, please note that the above embodiment is only for an illustrative purpose and is not meant to be a limitation of the present invention. For example, the number of the non-volatile memory units in the storage device 200 can be more than two.

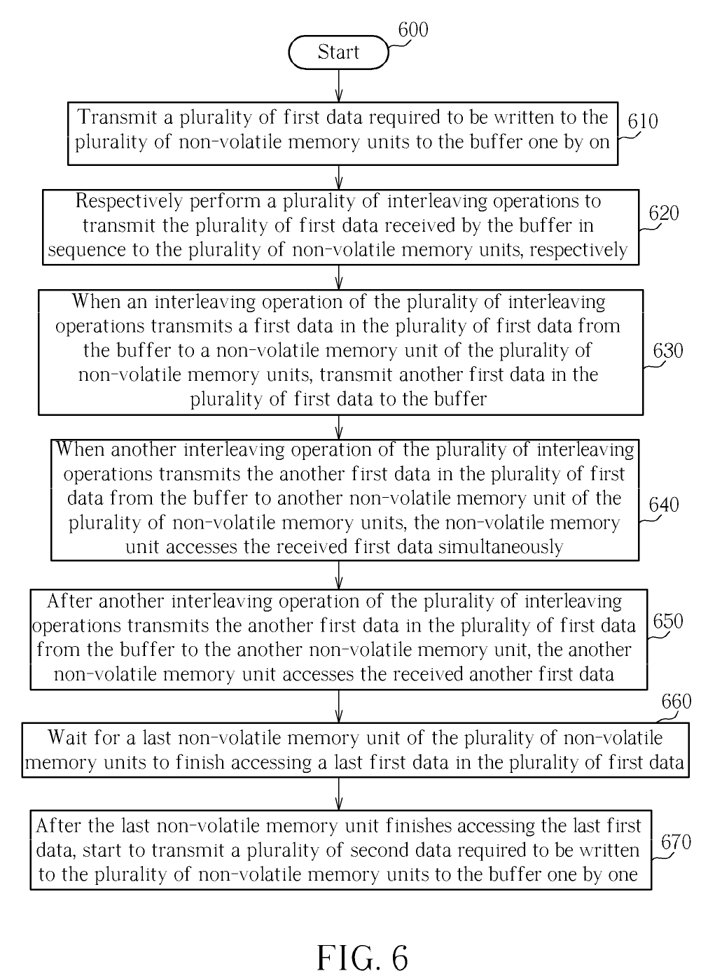

Please refer to FIG. 6. FIG. 6 is a second flowchart showing a data interleaving method that only needs to use one buffer for a storage device in accordance with the operation schemes of the storage device 200 in the above embodiment of the present invention. Provided that substantially the same result is achieved, the steps of the process flowchart need not be in the exact order shown in FIG. 6 and need not be contiguous, that is, other steps can be intermediate. The method in accordance with the second embodiment of the present invention comprises the following steps:

Step 600: Start.

Step 610: Transmit a plurality of first data required to be written to the plurality of non-volatile memory units to the buffer one by on.

Step 620: Respectively perform a plurality of interleaving operations to transmit the plurality of first data received by the buffer in sequence to the plurality of non-volatile memory units, respectively.

Step 630: When an interleaving operation of the plurality of interleaving operations transmits a first data in the plurality of first data from the buffer to a non-volatile memory unit of the plurality of non-volatile memory units, transmit another first data in the plurality of first data to the buffer.

Step 640: When another interleaving operation of the plurality of interleaving operations transmits the another first data in the plurality of first data from the buffer to another non-volatile memory unit of the plurality of non-volatile memory units, the non-volatile memory unit accesses the received first data simultaneously.

Step 650: After another interleaving operation of the plurality of interleaving operations transmits the another first data in the plurality of first data from the buffer to the another non-volatile memory unit, the another non-volatile memory unit accesses the received another first data.

Step 660: Wait for a last non-volatile memory unit of the plurality of non-volatile memory units to finish accessing a last first data in the plurality of first data.

Step 670: After the last non-volatile memory unit finishes accessing the last first data, start to transmit a plurality of second data required to be written to the plurality of non-volatile memory units to the buffer one by one.

Briefly summarized, the data interleaving method for a storage device and the related storage device disclosed by the present invention only needs to use one buffer, and thus the method and the related storage device of the present invention can reduce the required number of the buffer.

Those skilled in the art will readily observe that numerous modifications and alterations of the device and method may be made while retaining the teachings of the invention.

What is claimed is:

1. A data interleaving method for a storage device, the storage device comprising a plurality of non-volatile memory units and a buffer, the method comprising:
transmitting a plurality of first data required to be written to the plurality of non-volatile memory units to the buffer one by one; and
respectively performing a plurality of interleaving operations to transmit the plurality of first data received by the buffer in sequence to the plurality of non-volatile memory units, respectively.

2. The method of claim 1, wherein after an interleaving operation of the plurality of interleaving operations transmits a first data in the plurality of first data from the buffer to a non-volatile memory unit of the plurality of non-volatile memory units, transmitting another first data in the plurality of first data to the buffer, and the non-volatile memory unit accesses the received first data simultaneously; and after another interleaving operation of the plurality of interleaving operations transmits the another first data in the plurality of first data from the buffer to another non-volatile memory unit of the plurality of non-volatile memory units, the another non-volatile memory unit accesses the received another first data.

3. The method of claim 2, further comprising:
waiting for a last non-volatile memory unit of the plurality of non-volatile memory units to finish accessing a last first data in the plurality of first data; and
after the last non-volatile memory unit finishes accessing the last first data, starting to transmit a plurality of second data required to be written to the plurality of non-volatile memory units to the buffer one by one.

4. The method of claim 1, wherein when an interleaving operation of the plurality of interleaving operations transmits a first data in the plurality of first data from the buffer to a non-volatile memory unit of the plurality of non-volatile memory units, transmitting another first data in the plurality of first data to the buffer; when another interleaving operation of the plurality of interleaving operations transmits the another first data in the plurality of first data from the buffer to another non-volatile memory unit of the plurality of non-volatile memory units, the non-volatile memory unit accesses the received first data simultaneously; and after another interleaving operation of the plurality of interleaving operations transmits the another first data in the plurality of first data from the buffer to the another non-volatile memory unit, the another non-volatile memory unit accesses the received another first data.

5. The method of claim 4, further comprising:
waiting for a last non-volatile memory unit of the plurality of non-volatile memory units to finish accessing a last first data in the plurality of first data; and
after the last non-volatile memory unit finishes accessing the last first data, starting to transmit a plurality of second data required to be written to the plurality of non-volatile memory units to the buffer one by one.

6. The method of claim 1, wherein the plurality of non-volatile memory units are NAND type flash memories.

7. The method of claim 1, wherein the storage device is a solid state drive (SSD).

8. A storage device, comprising:
a plurality of non-volatile memory units;
a buffer, coupled to the plurality of non-volatile memory units; and
a processing unit, coupled to the plurality of non-volatile memory units and the buffer, for transmitting a plurality of first data required to be written to the plurality of non-volatile memory units to the buffer one by one, and respectively performing a plurality of interleaving operations to transmit the plurality of first data received by the buffer in sequence to the plurality of non-volatile memory units, respectively.

9. The storage device of claim 8, wherein after the processing unit performs an interleaving operation of the plurality of interleaving operations transmits a first data in the plurality of first data from the buffer to a non-volatile memory unit of the plurality of non-volatile memory units, the processing unit transmits another first data in the plurality of first data to the buffer, and the non-volatile memory unit accesses the received first data simultaneously; and after the processing unit performs another interleaving operation of the plurality of interleaving operations transmits the another first data in the plurality of first data from the buffer to another non-volatile memory unit of the plurality of non-volatile memory units, the another non-volatile memory unit accesses the received another first data.

10. The storage device of claim 9, wherein the processing unit waits for a last non-volatile memory unit of the plurality of non-volatile memory units to finish accessing a last first data in the plurality of first data; and after the last non-volatile memory unit finishes accessing the last first data, the processing unit starts to transmit a plurality of second data required to be written to the plurality of non-volatile memory units to the buffer one by one.

11. The storage device of claim 8, wherein when the processing unit performs an interleaving operation of the plurality of interleaving operations transmits a first data in the plurality of first data from the buffer to a non-volatile memory unit of the plurality of non-volatile memory units, the processing unit transmits another first data in the plurality of first data to the buffer; when the processing unit performs another interleaving operation of the plurality of interleaving operations transmits the another first data in the plurality of first data from the buffer to another non-volatile memory unit of the plurality of non-volatile memory units, the non-volatile memory unit accesses the received first data simultaneously; and after the processing unit performs another interleaving operation of the plurality of interleaving operations transmits the another first data in the plurality of first data from the buffer to the another non-volatile memory unit, the another non-volatile memory unit accesses the received another first data.

12. The storage device of claim 11, wherein the processing unit waits a last non-volatile memory unit of the plurality of non-volatile memory units to finish accessing a last first data in the plurality of first data; and after the last non-volatile memory unit finishes accessing the last first data, the processing unit starts to transmit a plurality of second data required to be written to the plurality of non-volatile memory units to the buffer one by one.

13. The storage device of claim 8, wherein the plurality of non-volatile memory units are NAND type flash memories.

14. The storage device of claim 8, wherein the storage device is a solid state drive (SSD).
